(19) United States
(12) Patent Application Publication
(10) Pub. No.: US 2024/0283820 A1
(43) Pub. Date: Aug. 22, 2024

(54) AUTOMATED MACHINE LEARNING USING LARGE LANGUAGE MODELS

(71) Applicant: MICROSOFT TECHNOLOGY LICENSING, LLC, Redmond, WA (US)

(72) Inventors: Sebastian J. KOCHMAN, Redmond, WA (US); Geoffrey Lyall MCDONALD, Vancouver (CA)

(21) Appl. No.: 18/110,847

(22) Filed: Feb. 16, 2023

(51) Int. Cl. H04L 9/40

(52) U.S. Cl. CPC H04L 63/1483

(57) ABSTRACT

The techniques described herein enhance the operation of automated machine learning platforms by utilizing large language models for automated featurization. For example, given an input dataset, a large language model can determine the context of the input dataset and generate a variety of different featurization approaches. Each featurization approach can include a feature set derived from the input dataset. In the present context, a feature defines a relationship between portions of the input dataset. Consequently, good feature selection translates directly to machine learning model performance. A set of machine learning models is then trained and evaluated using the featurization approaches generated by the large language model and the input dataset. Evaluation is performed using a metric selected based on the machine learning task. The machine learning models can then be ranked and the machine learning model with the greatest performance can then be selected for deployment.

### BACKGROUND

Recent years have seen the rapid growth in the capability and sophistication of artificial intelligence (AI) and machine learning (ML) software applications. For instance, transformer-based large language models (LLMs) have seen widespread adoption due to their diverse processing capabilities in vision, speech, language, and decision making. Unlike other AI models such as recurrent neural networks and long short-term memory (LSTM) models, transformer-based large language models make use of a native self-attention mechanism to identify vague context from limited available data and even synthesize new content from images and music to software. Commensurate with their capabilities, large language models are complex, oftentimes comprising millions if not billions of individual parameters. Accordingly, various organizations deploy large-scale computing infrastructure, such as cloud computing, to offer AI platforms tailored to enabling users make use of cutting-edge large language models.

The ability of large language models to identify and work within vague or indefinite contexts allows large language models to mimic human intuition and expertise when solving problems and/or generating content. This ability can be leveraged in highly technical applications where existing methods can lack performance. For example, many cloud computing providers offer automated machine learning tools to enable users who may not be experts in the field to train and deploy machine learning models of their own. Such tools typically involve training a machine learning model using an input dataset to perform a certain task (e.g., regression, classification). Typically, an input dataset is formatted into rows and columns in which each row represents an entity having various features which are represented by the columns.

A crucial step in the training process is featurization, which is also known as feature engineering or feature augmentation. While raw data from the input dataset can be used to train a machine learning model, it is often necessary to create additional (i.e., engineered) features that illuminate patterns in the input data. This process is called feature engineering and is often performed manually by a user leveraging specific domain knowledge to create features that allow machine learning models to learn more effectively. In addition, various techniques such as data-scaling and normalization can be employed to augment feature engineering and form an overall featurization approach. In some instances, featurization can be automated using various heuristic algorithms to implement various preprogrammed rules. However, as mentioned, existing approaches to featurization can be demanding and time-consuming for a user if performed manually while automated methods may lack flexibility and adaptability to provide consistent, high-quality results.

### SUMMARY

The techniques described herein provide systems for enhancing automated machine learning training workflows by introducing large language models for automated featurization. As mentioned above, the ability of large language models (LLMs) to identify vague contexts from input data allows large language models to mimic human intuition and specific domain knowledge. As such, large language models are uniquely suited among artificial intelligence (AI) solutions for performing automated featurization.

In contrast, existing approaches for automated featurization often utilize heuristic algorithms that implement predetermined, manually designed rules for an input dataset. These heuristic algorithms often lack the ability to adapt to and/or understand the input data and features. Moreover, these heuristic algorithms lack the creativity to produce a variety of methods and the insight a human expert brings to the problem. Consequently, such solutions may fail to achieve satisfactory performance in various applications and map poorly to implementations designed by a human expert.

Accordingly, deploying a large language model addresses these technical challenges while enabling additional technical benefits. For example, unlike a heuristic algorithm, a large language model can be initialized to process an input dataset with minimal effort demanded of a user. That is, while a heuristic algorithm executes predetermined rules, a large language model can pseudo-intelligently form such rules automatically based on the input dataset (e.g., dataset schema, statistical distribution of values). In this way, the system disclosed herein can reduce manual inputs required to set up and execute a machine learning experiment and enable a broader userbase with little or no technical background to train and deploy machine learning models.

In another example of the technical benefit of the present disclosure, a large language model can provide higher quality featurization and feature augmentation compared to typical approaches. This is again due to the ability of the large language model to identify context and mimic the intuition and expertise of a human data scientist. As such, the features generated by the large language model can often illuminate more complex and/or non-obvious patterns in the input dataset that typical automation methods may fail to identify. A higher quality featurization approach can lead to more effective machine learning models thereby enabling performance improvements in broad application spaces.

In still another example of the technical benefit of the present disclosure, utilizing a large language model for machine learning pipeline generation can improve the efficiency of the overall machine learning platform. As mentioned above, a large language model can produce machine learning pipelines of a similar quality to a human expert. As such, the disclosed system can reduce the number of candidate machine learning pipelines and resulting machine learning models required to reach a final solution. Consequently, this reduces the computing resources and time required to evaluate and determine a final machine learning solution. In this way, the techniques discussed herein can broadly improve computing resource utilization and efficiency.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 is a block diagram of a system for performing automated machine learning pipeline generation and execution, which is guided by featurization through a large language model.

FIG. 2A illustrates an example of a first featurization approach for a first input dataset.

FIG. 2B illustrates an example of a second featurization approach for the first input dataset.

FIG. 3 illustrates an example of a featurization approach for a second input dataset.

FIG. 4 is a block diagram illustrating additional aspects of an automated machine learning training module.

FIG. 5 is a flow diagram showing aspects of a routine for performing load testing and performance benchmarking for artificial intelligence models using a cloud computing platform.

FIG. 6 is a computer architecture diagram illustrating an illustrative computer hardware and software architecture for a computing system capable of implementing aspects of the techniques and technologies presented herein.

FIG. 7 is a diagram illustrating a distributed computing environment capable of implementing aspects of the techniques and technologies presented herein.

### DETAILED DESCRIPTION

The techniques described herein enhance the operation of automated machine learning (ML) training platforms by utilizing large language models for automated featurization. For example, given an input dataset, a large language model can determine the context of the input dataset and derive a variety of different featurization approaches. Each featurization approach can include a feature set that reflects the featurization approach. For instance, one featurization approach may determine that a particular feature of the input dataset is especially important. Accordingly, the resulting feature set may contain features that analyze the feature and its interactions with other features. Conversely, a feature that the featurization approach does not deem consequential can receive less analysis through fewer engineered features. In addition, each featurization approach can include a corresponding set of data transforms (e.g., data-scaling, normalization) which are applied to the input dataset to complete the featurization process. It should be noted that, by applying a plurality of featurization approaches, the large language model effectively creates a corresponding plurality of input datasets.

The system can subsequently utilize the input datasets to initialize a plurality of candidate machine learning pipelines which serve to implement and execute an associated featurization approach upon the input dataset. As such, an individual candidate machine learning pipeline can implement different engineered features and/or data transforms to process the input dataset. The candidate machine learning pipelines can utilize any suitable type of machine learning model and can be selected based on a task associated with the input dataset (e.g., regression, classification).

An automated machine learning training workflow can then execute the candidate machine learning pipelines using the input dataset which involves training a machine learning model. In addition, the candidate machine learning pipelines can be evaluated using a task-specific evaluation metric such as mean absolute error (MAE) for regression tasks or area under curve (AUC) for binary classification tasks. Accordingly, the evaluation metric can be a mathematical calculation and resulting numerical representation of machine learning performance for a specific task.

Furthermore, the candidate machine learning pipelines can be ranked by the automated machine learning training workflow. Accordingly, a top-ranking machine learning pipeline having the greatest performance based on the evaluation metric can be selected as the “winning” solution. In this way, a user with minimal machine learning expertise can train and deploy machine learning models that are more accurate and effective than existing solutions (e.g., the use of heuristic algorithms).

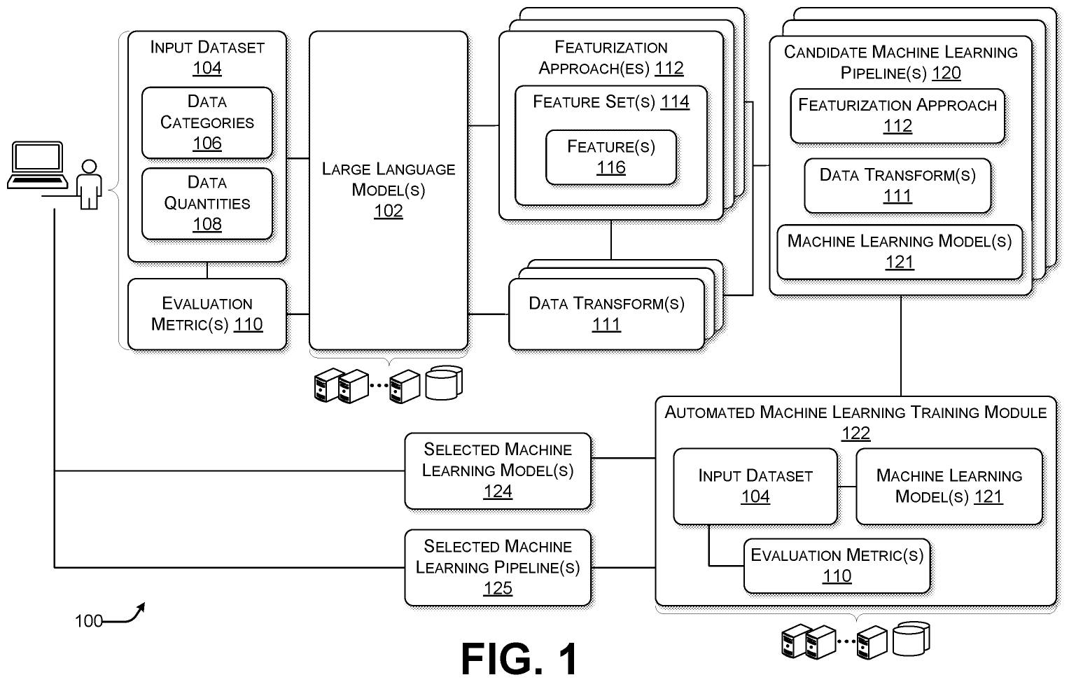

Various examples, scenarios, and aspects that enable automated machine learning pipeline generation and execution using large language models are described below with respect to FIGS. 1-7.

FIG. 1 illustrates a system 100 that enables automated machine learning pipeline generation and execution using a large language model 102. In various examples, the system 100 can be implemented as a service in a cloud computing platform. The system 100 can accordingly leverage the abundant computing resources of the cloud computing platform to execute machine learning tasks. As shown in FIG. 1, the large language model 102 can receive an input dataset 104 comprising various data categories 106 and associated data quantities 108. For the sake of discussion, a data category 106 can be understood as defining a measured property (e.g., height and weight) whereas a data quantity 108 defines a measured value for a data category 106 (e.g., two meters and one hundred kilos respectively).

In addition, the large language model 102 can receive an evaluation metric 110 that is associated with the input dataset 104. The evaluation metric 110 can be selected based on a task associated with the input dataset 104. For example, the input dataset 104 may be configured to train a machine learning model to perform binary classification (e.g., determining whether a link is malicious). Accordingly, the evaluation metric 110 can be an area under curve (AUC) metric defining the difference between the output of a machine learning model relative to the ground truth of the input dataset 104. In another example, the input dataset 104 may be configured to train a machine learning model to perform regression (e.g., predicting a wine quality score, detecting a security issue such as installed malware on a device). For this task, the appropriate evaluation metric 110 is a rate of mean absolute error (MAE) to measure the accuracy of the machine learning model. The evaluation metric 110 can be utilized by the system 100 to compare training results for various candidate machine learning models.

From an analysis of the input dataset 104, the large language model 102 can generate a set of data transforms 111 for application to the input dataset 104. In various examples, the data transforms 111 can apply mandatory transformations to the input dataset 104 such as resizing and converting non-numeric features into numeric features. These data transforms 111 can format the input dataset 104 to be compatible with a machine learning model. In addition, the data transforms 111 can include optional quality transformations such as tokenization of text features, normalization for numeric features, and so forth. Moreover, the data transforms 111 can be generated based on a data types present in the input dataset 104. In various examples, data transform 111 outputs of the large language model 102 can be formatted as software using any suitable programming language.

In addition, the large language model 102 can generate various featurization approaches 112 for the input dataset 104. In various examples, a featurization approach 112 can be understood as a general guidance that is generated by the large language model 102 when analyzing the input dataset 104 (e.g., important characteristics and/or relationships to investigate). Accordingly, each featurization approach 112 can define an associated feature set 114 that contains features 116 that are derived from the input dataset 104 and implement the ideas conceived by the large language model 102 in the featurization approach. In addition, the data transforms 111 for a first featurization approach 112 can be the same for a second featurization approach 112. Conversely, the data transforms 111 may differ between featurization approaches 112 depending on technical needs. Similar to the data transforms 111, the feature sets 114 can also be output as software using any suitable programming language.

In the context of the present disclosure, a feature 116 can be understood as a measurable property or characteristic of a given subject. For instance, the data categories 106 and data quantities 108 of the input dataset 104 are an example of features. Consequently, the features 116 generated by the large language model 102 can be considered engineered features as discussed above. These features 116 can represent an interaction between two or more features (data categories 106 and data quantities 108) of the input dataset 104. As will be elaborated upon below, the features 116 of a feature set 114 establish connections between various data categories 106 to illuminate broad patterns and interactions between features within the input dataset 104.

Based on the generated featurization approaches 112, a plurality of candidate machine learning pipelines 120 can be initialized for training. Each candidate machine learning pipeline 120 can implement a different featurization approach 112 and/or associated data transform 111 as well as a machine learning model 121. In addition, a user can manually select the machine learning model 121 for the candidate machine learning pipeline 120 to suit various tasks (e.g., a regression model, a binary classifier). Conversely, the machine learning model 121 can be automatically selected by the system 100. For the sake of clarity, each candidate machine learning pipeline 120 can comprise a set of pipeline stages defined by the large language model 102. In a specific example, the pipeline stages can be constructed by the large language model 102 using few-shot learning due to the relative sparsity of a typical input dataset 104 (e.g., dozens of samples vs millions).

The candidate machine learning models 120 can then be provided to an automated machine learning training module 122 for training and evaluation. As shown in FIG. 1, the automated machine learning training module 122 can be configured with the input dataset 104 which the automated machine learning training module 122 then uses to train the machine learning models 121. The final performance of the machine learning models 121 can be quantified using the evaluation metric 110. In various examples, the performance of a machine learning model 121 can accordingly reflect the performance of a candidate machine learning pipeline 120 which produced the machine learning model 121. As such, the candidate machine learning pipelines 120 and/or the machine learning models 121 can be ranked based on the evaluation metric 110. The automated machine learning training module 122 can subsequently output a “winning” selected machine learning model 124 and/or a “winning” selected machine learning pipeline 125.

In various examples, the selected machine learning model 124 can be the machine learning model 121 that resulted in a higher performance relative to the other machine learning models 121 for a given machine learning task according to the ranking based on the evaluation metric 110. That is, for a set of machine learning models 121 that are evaluated by the automated machine learning training module 122, the selected machine learning model 124 can be the highest ranked of the machine learning models 121. Moreover, the user may wish to analyze additional details and can optionally receive the selected machine learning model 124 and/or the selected machine learning pipeline 125. For example, if the user wishes to deploy a machine learning model 121, the user may elect to utilize the selected machine learning model 124 and not the selected machine learning pipeline 125. Conversely, if the user wishes to gain additional insight, make modifications, or retrain, the user can utilize the selected machine learning pipeline 125 as well as the selected machine learning model 124.

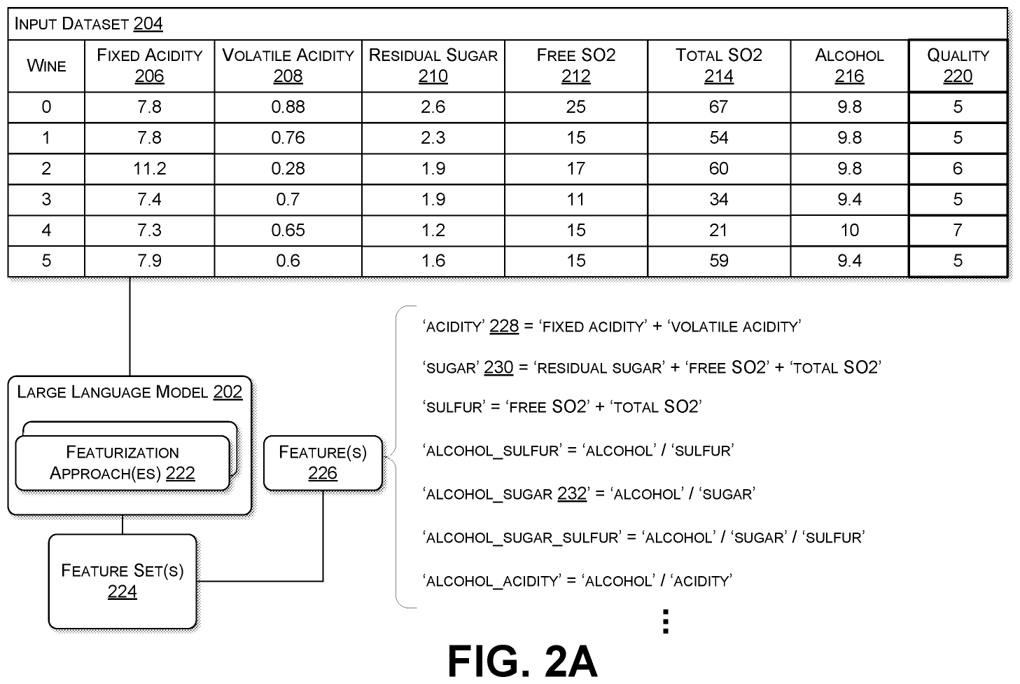

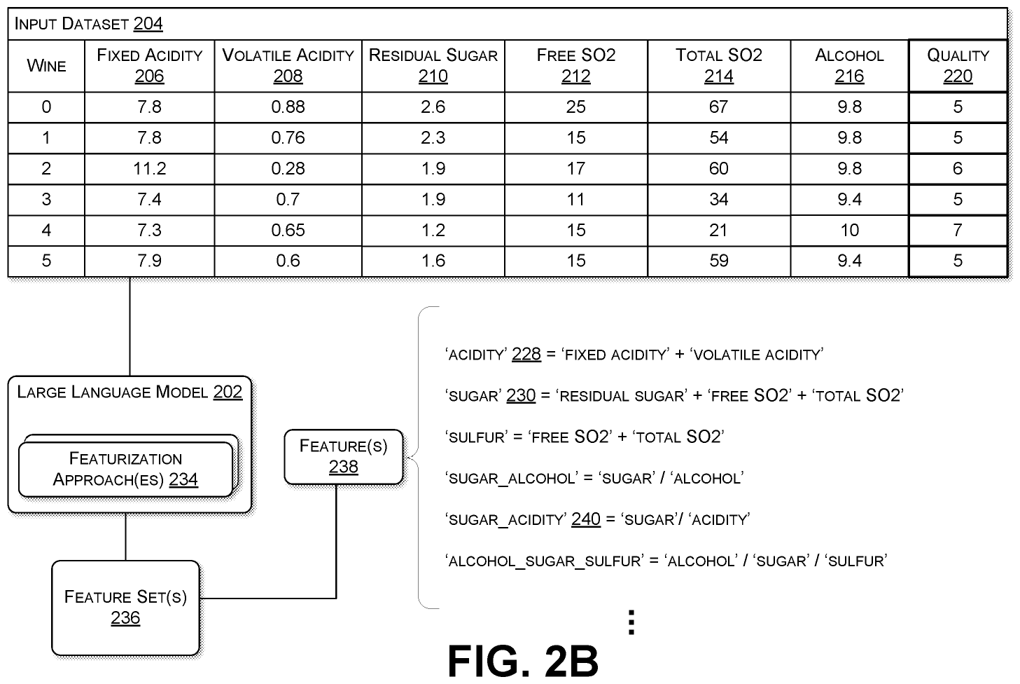

Turning now to FIG. 2A, aspects of an example featurization approach are shown and described. As shown, a large language model 202 can receive an input data set 204 comprising various data categories 206-218. In the present example, the input dataset 204 describes chemical properties of various wines. A common testbench in machine learning domains, the wine input dataset 204 can test the ability of a machine learning model to predict an overall quality 220. For the wine input dataset 204, a higher quality score 220 is considered better. As mentioned above, a key determinant of machine learning model performance is featurization and more specifically, feature engineering.

To that end, the large language model 202 can be configured to generate various featurization approaches 222 that translate to corresponding feature sets 224. Stated another way, the feature set 224 concretely expresses relationships between the data categories 206-218 in the input dataset 204 that are identified by the large language model 202. Naturally, the feature set 224 comprises individual features 226 that are derived from the input dataset 204. In various examples, a feature 226 can be a function of two or more data categories 206-218. For instance, the large language model 202 may generate an acidity feature 228 that represents an overall acidity for a given wine. Accordingly, the acidity feature 228 can be defined as an aggregate or sum of the fixed acidity 206 and volatile acidity 208 from the input dataset 204. Similarly, the large language model 202 can generate a sugar feature 230 to represent an overall sugar content. Consequently, the sugar feature 230 can be defined as the sum of the residual sugar 210, free sulfur dioxide 212, and total sulfur dioxide 214.

In another example, a feature 226 generated by the large language model 202 can be a comparison between two or more data categories 206-218. Alternatively, the feature 226 may also incorporate engineered features such as acidity 228 or sugar 230. For instance, an “alcohol_sugar” feature 232 can be defined as the ratio of alcohol to overall sugar content in each wine. Intuitively, the ratio of alcohol to sugar may significantly impact the quality of a wine, and thus, may be worthy of consideration when predicting a quality score 220.

In this way, the large language model 202 mimics human-like intuition and specific information to derive new, higher-level features 226 from the input dataset 204. As discussed above, by applying specific information that is relevant to the current task, the large language model 202 can produce machine learning pipelines which result in machine learning models that outperform existing approaches. The large language model 202 can also use and reuse engineered features 226 as part of the featurization approach 222. Consequently, the large language model 202 can observe deeper interactions in the input dataset 204 resulting in higher quality machine learning models compared to existing training and featurization methods.

Proceeding to FIG. 2B, aspects of a second featurization approach 234 for the input dataset 204 are shown and described. As discussed above with respect to FIG. 1, the large language model 202 can generate a plurality of different featurization approaches 112 to determine which results in a machine learning model with the greatest performance based on an evaluation metric 110. Stated another way, a first featurization approach 222 can investigate and prioritize different aspects of the input dataset 204 in relation to a second featurization approach 234. Accordingly, the featurization approach 234 can cause the large language model 202 to generate a feature set 236 that contains features 238 that differ from the features 226 discussed above.

For example, as shown in FIG. 2B, the feature set 236 can include a “sugar_acidity” feature 240 which is not present in the feature set 224 which defines a ratio of overall sugar content to overall acidity in a given wine. However, it should be understood that the feature set 236 can also include some of the same features 238 as the feature set 224 such as the acidity feature 228 and sugar feature 230. In this way, the large language model 202 can uncover how subtle differences in featurization can affect the final quality of machine learning models. Moreover, by investigating many different featurization approaches, the large language model can find a feasibly optimal featurization approach 222 to produce performant machine learning models.

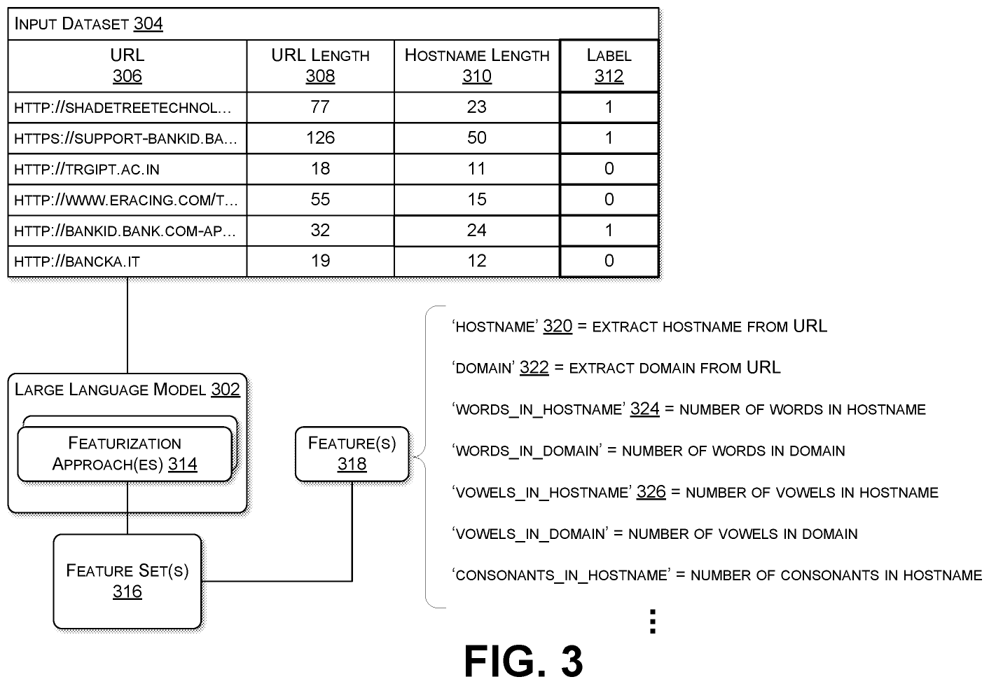

Turning now to FIG. 3, another example illustrating featurization capabilities of a large language model 302 is shown and described. In the example of FIG. 3, the large language model 302 receives an input dataset 304 comprising various uniform resource locators (URLs) 306 as well as some properties of the URLs 306 such as URL length 308 and hostname length 310. As mentioned above with respect to FIGS. 2A and 2B, the wine input dataset 204 is a common tool for training and demonstrating machine learning functionality for regressions tasks (e.g., predicting a quality score 220). In a similar way, the input dataset 304 shown in FIG. 3 can be utilized to train machine learning models for binary classification tasks. In the present example specifically, the machine learning model is challenged to predict whether a URL 306 is malicious (e.g., executes malware, phishing schemes) indicated by a label 312 which is shown in bold in FIG. 3. For instance, a label 312 of “0” indicates a benign URL 306 whereas a “1” indicates a malicious URL 306.

Similar to the above examples, the large language model 302 can analyze the input dataset 304 and generate one or many featurization approaches 314. A featurization approach 314 can accordingly be expressed as a feature set 316 containing a plurality of features 318. However, unlike the scenarios discussed above, the present input dataset 304 may contain relatively little information. In the present example, the input dataset 304 may only have a URL 306, a URL length 308, and a hostname length 310. Consequently, the large language model 302 must generate more complex features 318 that capture deeper and/or more specific patterns in the input dataset 304. For example, the URLs 306 in the input dataset 304 may be formatted as a text string. Accordingly, the large language model 302 can perform various text analyses techniques using the features 318 to extract salient information from the URL 306 to inform a final conclusion.

In various examples, the features 318 can extract certain subdivisions such as a substring of the larger URL 306. For instance, the features 318 can include a “hostname” feature 320 for extracting a substring identifying a computing device or other entity connected to a computer network responsible for delivering content associated with the URL 306. In another example, the features 318 can include a “domain” feature 322 for extracting a substring identifying a website or other web resource accessed by the URL 306.

Using the “hostname” feature 320 and/or the “domain” name feature 322, the large language model 302 can derive additional features 318 to analyze these substrings of the URL 306 for common signs of a malicious link. For example, a “words_in_hostname” feature 324 can calculate the number of distinct words in the hostname 320. In various examples, a large number of words in a hostname tends to indicate a more suspicious URL 306 relative to a URL 306 with fewer words in the hostname 320. In another example, a “vowels_in_hostname” feature 326 can calculate the number of vowels in the hostname 320. Similar analysis can be performed on the domain 322 as well as other portions of the URL 306. It should be understood that the features 318 shown and discussed in FIG. 3 are not exhaustive and can include other substrings of the URL 306, other text analysis techniques such as character and/or word n-grams, and the like.

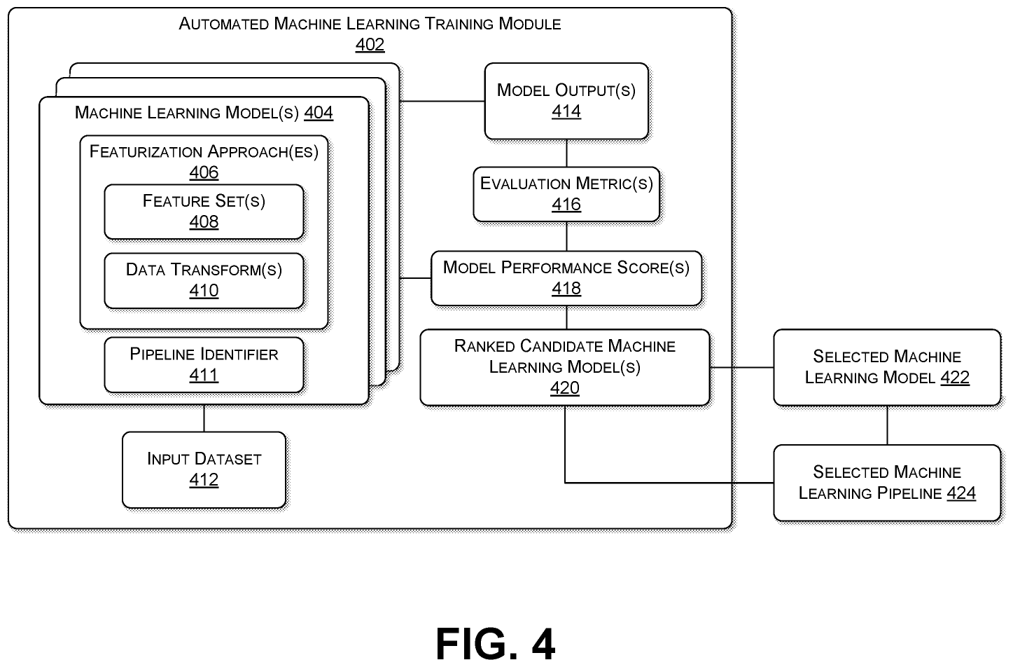

Turning now to FIG. 4, aspects of an automated machine learning training module 402 are shown and described. As discussed above with respect to FIG. 1, a set of machine learning models 404 from a corresponding set of machine learning pipelines can be initialized using the featurization approaches 406 expressed as feature sets 408 and data transforms 410. In addition, each machine learning model 404 can include a pipeline identifier 411 indicating an associated machine learning pipeline which produced the machine learning model 404. Accordingly, the machine learning models 404 can then be configured by the automated machine learning training module 402 to process an associated input dataset 412 as part of the training process. That is, the input dataset 412 used by the automated machine learning training module 402 to train the machine learning models 404 can be a same input dataset analyzed by a large language model to generate the featurization approaches 406 (e.g., input dataset 204 and large language model 202 respectively).

Once initialized, the machine learning models 404 can process the input dataset 412 to perform a specified machine learning task (e.g., regression, binary classification) and generate model outputs 414. The model outputs 414 can be a numerical score, a true/false statement, or other output utilizing any suitable data type. For example, the examples discussed above with respect to FIGS. 2 and 3 respectively challenge a machine learning model to predict an overall quality score 220 for wine and predict a label 312 indicating whether a URL 306 is malicious. In these examples, the quality score 220 and the label 312 of the respective input datasets 204 and 304 are the target of the model outputs 414.

The model outputs 414 can then be evaluated by the automated machine learning training module 402 using an evaluation metric 416. As mentioned above, the evaluation metric 416 can be predefined based on the machine learning task associated with the input dataset 412. Based on the evaluation metric 416, the automated machine learning training module 402 can derive an overall model performance score 418 for each machine learning model 404. In various examples, the model outputs 414, evaluation metrics 416, and/or the model performance 418 can be fed back to the machine learning models 404 to generate updated iterations of the machine learning models 404 and advance the training process.

Furthermore, the automated machine learning training module 402 can construct a list of ranked machine learning models 420 based on the model performance scores 418. In various examples, the list of ranked machine learning models 420 can be constructed after completion of the training process. Stated another way, the list of ranked machine learning models 420 can be compiled after the model performance scores 418 have reached a maximum value and/or a predefined number of training iterations has elapsed. Conversely, the automated machine learning training module 402 can be configured to generate the list of ranked machine learning models 420 at the beginning of the training process and subsequently updated after each iteration. In this way can gain insight on how featurization approaches 406 generated by a large language model affect model performance scores 418 over time.

Following a conclusion of the training process, the automated machine learning training module 402 can output a selected machine learning model 422 from the list of ranked machine learning models 420. The selected machine learning model 422 can be a machine learning model 404 having a maximum model performance score 418 relative to other machine learning models 404. Stated alternatively, the selected machine learning model 422 implements a most effective featurization approach 406 of the featurization approaches generated by a large language model. In addition, as discussed above, the automated machine learning training module 402 can also be configured to output a selected machine learning pipeline 424 that produced the selected machine learning model 422. In various examples, the selected machine learning pipeline 424 can be output with or instead of the selected machine learning model 422.

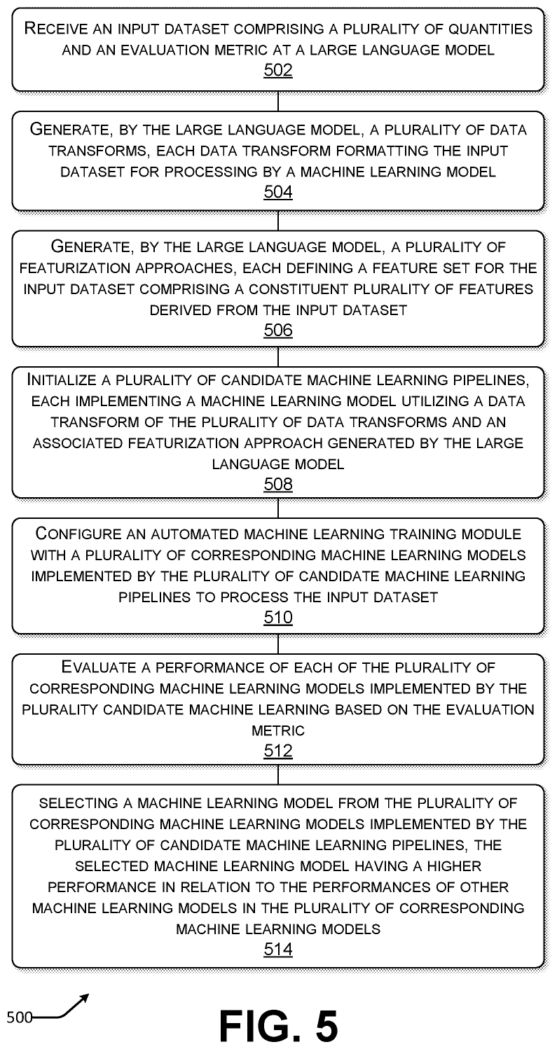

Proceeding to FIG. 5, aspects of a routine 500 for performing automated machine learning model training using large language models. With reference to FIG. 5, the routine 500 beings at operation 502 where a large language model receives an input dataset comprising a plurality of quantities and an evaluation metric.

Next at operation 504, the large language model generates a plurality of data transforms, each data transform formatting the input dataset for processing by a machine learning model.

Then, at operation 506, the large language model generates a plurality of featurization approaches, each featurization approach defining a feature set for the input dataset comprising a constituent plurality of features derived from the input dataset.

Subsequently, at operation 508, the system initializes a plurality of candidate machine learning pipelines, each implementing a machine learning model utilizing a data transform of the plurality of data transforms and an associated featurization approach generated by the large language model.

Then, at operation 510, the system configures an automated machine learning training module with a plurality of corresponding machine learning models implemented by the plurality of candidate machine learning pipelines to process the input dataset.

Next, at operation 512, the automated machine learning training module evaluates a performance of each of the plurality of corresponding machine learning models implemented by the plurality candidate machine learning based on the evaluation metric.

Finally, at operation 514, the automated machine learning training module selects a machine learning model from the plurality of corresponding machine learning models implemented by the plurality of candidate machine learning pipelines, the selected machine learning model having a higher performance in relation to the performances of other machine learning models in the plurality of corresponding machine learning models.

For ease of understanding, the processes discussed in this disclosure are delineated as separate operations represented as independent blocks. However, these separately delineated operations should not be construed as necessarily order dependent in their performance. The order in which the process is described is not intended to be construed as a limitation, and any number of the described process blocks may be combined in any order to implement the process or an alternate process. Moreover, it is also possible that one or more of the provided operations is modified or omitted.

The particular implementation of the technologies disclosed herein is a matter of choice dependent on the performance and other requirements of a computing device. Accordingly, the logical operations described herein are referred to variously as states, operations, structural devices, acts, or modules. These states, operations, structural devices, acts, and modules can be implemented in hardware, software, firmware, in special-purpose digital logic, and any combination thereof. It should be appreciated that more or fewer operations can be performed than shown in the figures and described herein. These operations can also be performed in a different order than those described herein.

It also should be understood that the illustrated methods can end at any time and need not be performed in their entireties. Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the routine 500 can be implemented, at least in part, by modules running the features disclosed herein can be a dynamically linked library (DLL), a statically linked library, functionality produced by an application programing interface (API), a compiled program, an interpreted program, a script, or any other executable set of instructions. Data can be stored in a data structure in one or more memory components. Data can be retrieved from the data structure by addressing links or references to the data structure.

Although the illustration may refer to the components of the figures, it should be appreciated that the operations of the routine 500 may be also implemented in other ways. In addition, one or more of the operations of the routine 500 may alternatively or additionally be implemented, at least in part, by a chipset working alone or in conjunction with other software modules. In the example described below, one or more modules of a computing system can receive and/or process the data disclosed herein. Any service, circuit, or application suitable for providing the techniques disclosed herein can be used in operations described herein.

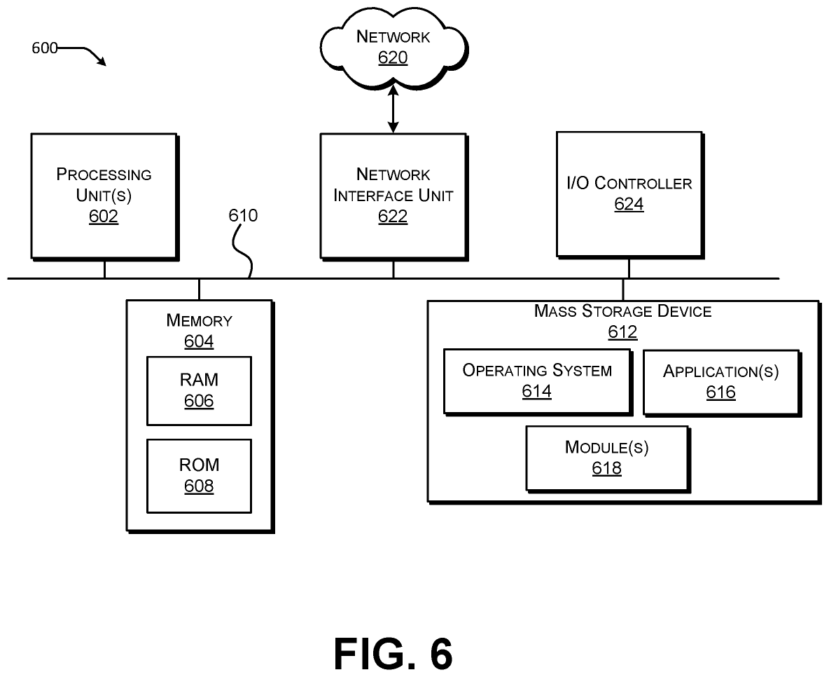

FIG. 6 shows additional details of an example computer architecture 600 for a device, such as a computer or a server configured as part of the cloud-based platform or system 100, capable of executing computer instructions (e.g., a module or a program component described herein). The computer architecture 600 illustrated in FIG. 6 includes processing system 602, a system memory 604, including a random-access memory 606 (RAM) and a read-only memory (ROM) 608, and a system bus 610 that couples the memory 604 to the processing system 602. The processing system 602 comprises processing unit(s). In various examples, the processing unit(s) of the processing system 602 are distributed. Stated another way, one processing unit of the processing system 602 may be located in a first location (e.g., a rack within a datacenter) while another processing unit of the processing system 602 is located in a second location separate from the first location.

Processing unit(s), such as processing unit(s) of processing system 602, can represent, for example, a CPU-type processing unit, a GPU-type processing unit, a field-programmable gate array (FPGA), another class of digital signal processor (DSP), or other hardware logic components that may, in some instances, be driven by a CPU. For example, illustrative types of hardware logic components that can be used include Application-Specific Integrated Circuits (ASICs), Application-Specific Standard Products (ASSPs), System-on-a-Chip Systems (SOCs), Complex Programmable Logic Devices (CPLDs), and the like.

A basic input/output system containing the basic routines that help to transfer information between elements within the computer architecture 600, such as during startup, is stored in the ROM 608. The computer architecture 600 further includes a mass storage device 612 for storing an operating system 614, application(s) 616, modules 618, and other data described herein.

The mass storage device 612 is connected to processing system 602 through a mass storage controller connected to the bus 610. The mass storage device 612 and its associated computer-readable media provide non-volatile storage for the computer architecture 600. Although the description of computer-readable media contained herein refers to a mass storage device, the computer-readable media can be any available computer-readable storage media or communication media that can be accessed by the computer architecture 600.

Computer-readable media includes computer-readable storage media and/or communication media. Computer-readable storage media includes one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including RAM, static RAM (SRAM), dynamic RAM (DRAM), phase change memory (PCM), ROM, erasable programmable ROM (EPROM), electrically EPROM (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer-readable storage media, communication media can embody computer-readable instructions, data structures, program modules, or other data in a modulated data signal, such as a carrier wave, or other transmission mechanism. As defined herein, computer storage media does not include communication media. That is, computer-readable storage media does not include communications media consisting solely of a modulated data signal, a carrier wave, or a propagated signal, per se.

According to various configurations, the computer architecture 600 may operate in a networked environment using logical connections to remote computers through the network 620. The computer architecture 600 may connect to the network 620 through a network interface unit 622 connected to the bus 610. The computer architecture 600 also may include an input/output controller 624 for receiving and processing input from a number of other devices, including a keyboard, mouse, touch, or electronic stylus or pen. Similarly, the input/output controller 624 may provide output to a display screen, a printer, or other type of output device.

The software components described herein may, when loaded into the processing system 602 and executed, transform the processing system 602 and the overall computer architecture 600 from a general-purpose computing system into a special-purpose computing system customized to facilitate the functionality presented herein. The processing system 602 may be constructed from any number of transistors or other discrete circuit elements, which may individually or collectively assume any number of states. More specifically, the processing system 602 may operate as a finite-state machine, in response to executable instructions contained within the software modules disclosed herein. These computer-executable instructions may transform the processing system 602 by specifying how the processing system 602 transition between states, thereby transforming the transistors or other discrete hardware elements constituting the processing system 602.

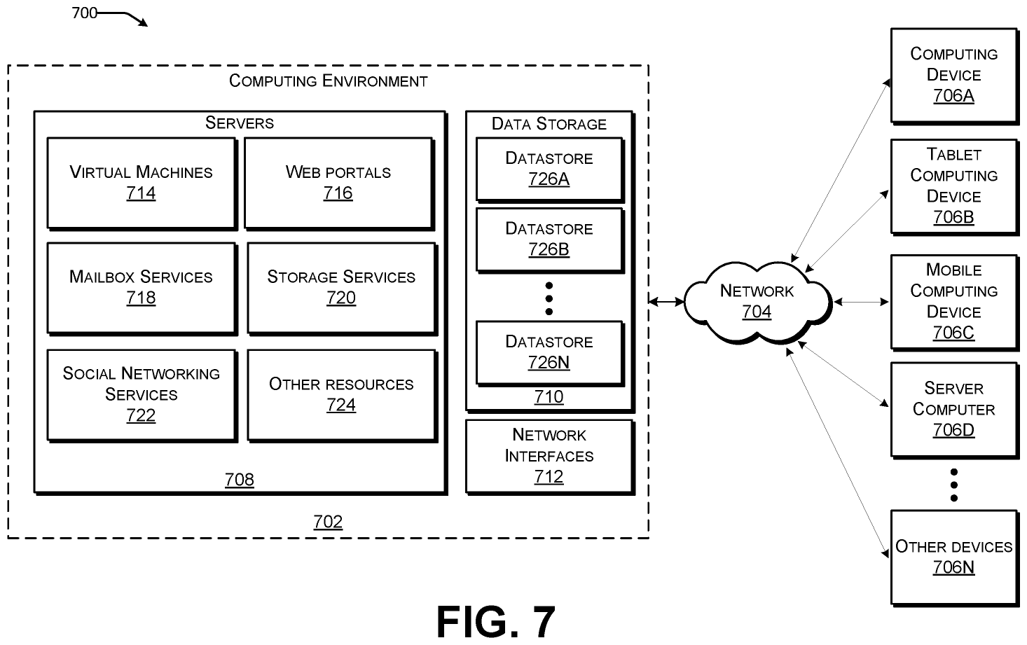

FIG. 7 depicts an illustrative distributed computing environment 700 capable of executing the software components described herein. Thus, the distributed computing environment 700 illustrated in FIG. 7 can be utilized to execute any aspects of the software components presented herein. For example, the distributed computing environment 700 can be utilized to execute aspects of the software components described herein.

Accordingly, the distributed computing environment 700 can include a computing environment 702 operating on, in communication with, or as part of the network 704. The network 704 can include various access networks. One or more client devices 706A-706N (hereinafter referred to collectively and/or generically as “computing devices 706”) can communicate with the computing environment 702 via the network 704. In one illustrated configuration, the computing devices 706 include a computing device 706A such as a laptop computer, a desktop computer, or other computing device; a slate or tablet computing device (“tablet computing device”) 706B; a mobile computing device 706C such as a mobile telephone, a smart phone, or other mobile computing device; a server computer 706D; and/or other devices 706N. It should be understood that any number of computing devices 706 can communicate with the computing environment 702.

In various examples, the computing environment 702 includes servers 708, data storage 610, and one or more network interfaces 712. The servers 708 can host various services, virtual machines, portals, and/or other resources. In the illustrated configuration, the servers 708 host virtual machines 714, Web portals 716, mailbox services 718, storage services 720, and/or social networking services 722. As shown in FIG. 7 the servers 708 also can host other services, applications, portals, and/or other resources (“other resources”) 724.

As mentioned above, the computing environment 702 can include the data storage 710. According to various implementations, the functionality of the data storage 710 is provided by one or more databases operating on, or in communication with, the network 704. The functionality of the data storage 710 also can be provided by one or more servers configured to host data for the computing environment 700. The data storage 710 can include, host, or provide one or more real or virtual datastores 726A-726N (hereinafter referred to collectively and/or generically as “datastores 726”). The datastores 726 are configured to host data used or created by the servers 808 and/or other data. That is, the datastores 726 also can host or store web page documents, word documents, presentation documents, data structures, algorithms for execution by a recommendation engine, and/or other data utilized by any application program. Aspects of the datastores 726 may be associated with a service for storing files.

The computing environment 702 can communicate with, or be accessed by, the network interfaces 712. The network interfaces 712 can include various types of network hardware and software for supporting communications between two or more computing devices including the computing devices and the servers. It should be appreciated that the network interfaces 712 also may be utilized to connect to other types of networks and/or computer systems.

It should be understood that the distributed computing environment 700 described herein can provide any aspects of the software elements described herein with any number of virtual computing resources and/or other distributed computing functionality that can be configured to execute any aspects of the software components disclosed herein. According to various implementations of the concepts and technologies disclosed herein, the distributed computing environment 700 provides the software functionality described herein as a service to the computing devices. It should be understood that the computing devices can include real or virtual machines including server computers, web servers, personal computers, mobile computing devices, smart phones, and/or other devices. As such, various configurations of the concepts and technologies disclosed herein enable any device configured to access the distributed computing environment 700 to utilize the functionality described herein for providing the techniques disclosed herein, among other aspects.

The disclosure presented herein also encompasses the subject matter set forth in the following clauses.

Example Clause A, a method comprising: receiving an input dataset comprising a plurality of quantities and an evaluation metric at a large language model; generating, by the large language model, a plurality of data transforms, each data transform of the plurality of data transforms formatting the input dataset for processing; generating, by the large language model, a plurality of featurization approaches, each featurization approach defining a feature set for the input dataset comprising a constituent plurality of features derived from the input dataset; initializing a plurality of candidate machine learning pipelines, each candidate machine learning pipeline implementing a corresponding machine learning model utilizing a data transform of the plurality of data transforms and an associated featurization approach generated by the large language model; configuring an automated machine learning training module with a plurality of corresponding machine learning models implemented by the plurality of candidate machine learning pipelines to process the input dataset; evaluating a performance of each of the plurality of corresponding machine learning models implemented by the plurality candidate machine learning based on the evaluation metric; and selecting a machine learning model from the plurality of corresponding machine learning models implemented by the plurality of candidate machine learning pipelines, the selected machine learning model having a higher performance in relation to the performances of other machine learning models in the plurality of corresponding machine learning models.

Example Clause B, the method of Example Clause A, wherein a feature of the constituent plurality of features is a ratio of two quantities of the plurality of quantities.

Example Clause C, the method of Example Clause A, wherein a feature of the constituent plurality of features is an aggregate quantity of a subset of the plurality of quantities.

Example Clause D, the method of Example Clause A, wherein a feature of the constituent plurality of features is a subdivision extracted from a quantity of the plurality of quantities.

Example Clause E, the method of Example Clause A, wherein a feature of the constituent plurality of features defines a characteristic of a quantity of the plurality of quantities.

Example Clause F, the method of any one of Example Clause A through E, wherein the plurality of data transforms is generated based on a data type of the input dataset.

Example Clause G, the method of any one of Example Clause A through F, wherein: the evaluation metric is selected based on a machine learning task associated with the input dataset; the machine learning task is a binary classification task identifying a malicious uniform resource locator; and the evaluation metric is an area under curve metric.

Example Clause H, a system comprising: one or more processing units; and a computer-readable medium having encoded thereon computer-readable instructions that when executed by the one or more processing units, causes the system to: receive an input dataset comprising a plurality of quantities and an evaluation metric at a large language model; generate, by the large language model, a plurality of data transforms, each data transform formatting the input dataset for processing; generate, by the large language model, a plurality of featurization approaches, each featurization approach defining a feature set for the input dataset comprising a constituent plurality of features derived from the input dataset; initialize a plurality of candidate machine learning pipelines, each candidate machine learning pipeline implementing a corresponding machine learning model utilizing a data transform of the plurality of data transforms and an associated featurization approach generated by the large language model; configure an automated machine learning training module with a plurality of corresponding machine learning models implemented by the plurality of candidate machine learning pipelines to process the input dataset; evaluate a performance of each of the plurality of corresponding machine learning models implemented by the plurality candidate machine learning based on the evaluation metric; and select a machine learning model from the plurality of corresponding machine learning models implemented by the plurality of candidate machine learning pipelines, the selected machine learning model having a higher performance in relation to the performances of other machine learning models in the plurality of corresponding machine learning models.

Example Clause I, the system of example clause H, wherein a feature of the constituent plurality of features is a ratio of two quantities of the plurality of quantities.

Example Clause J, the system of example clause H, wherein a feature of the constituent plurality of features is an aggregate quantity of a subset of the plurality of quantities.

Example Clause K, the system of example clause H, wherein a feature of the constituent plurality of features is a subdivision extracted from a quantity of the plurality of quantities.

Example Clause L, the system of example clause H, wherein a feature of the constituent plurality of features defines a characteristic of a quantity of the plurality of quantities.

Example Clause M, the system of any one of example clause H through L, wherein the plurality of data transforms is generated based on a data type of the input dataset.

Example Clause N, the system of any one of example clause H through M, wherein: the evaluation metric is selected based on a machine learning task associated with the input dataset; the machine learning task is a regression machine learning task for detecting a security issue; and the evaluation metric is a mean absolute error metric.

Example Clause O, a computer-readable storage medium having encoded thereon computer-readable instructions that when executed by a processing unit causes the system to: receive an input dataset comprising a plurality of quantities and an evaluation metric at a large language model; generate, by the large language model, a plurality of data transforms, each data transform formatting the input dataset for processing; generate, by the large language model, a plurality of featurization approaches, each featurization approach defining a feature set for the input dataset comprising a constituent plurality of features derived from the input dataset; initialize a plurality of candidate machine learning pipelines, each candidate machine learning pipeline implementing a corresponding machine learning model utilizing a data transform of the plurality of data transforms and an associated featurization approach generated by the large language model; configure an automated machine learning training module with a plurality of corresponding machine learning models implemented by the plurality of candidate machine learning pipelines to process the input dataset; evaluate a performance of each of the plurality of corresponding machine learning models implemented by the plurality candidate machine learning based on the evaluation metric; and select a machine learning model from the plurality of corresponding machine learning models implemented by the plurality of candidate machine learning pipelines, the selected machine learning model having a higher performance in relation to the performances of other machine learning models in the plurality of corresponding machine learning models.

Example Clause P, the computer-readable storage medium of Example Clause O, wherein a feature of the constituent plurality of features is a ratio of two quantities of the plurality of quantities.

Example Clause Q, the computer-readable storage medium of Example Clause O, wherein a feature of the constituent plurality of features is an aggregate quantity of a subset of the plurality of quantities.

Example Clause R, the computer-readable storage medium of Example Clause O, wherein a feature of the constituent plurality of features is a subdivision extracted from a quantity of the plurality of quantities.

Example Clause S, the computer-readable storage medium of Example Clause O, wherein a feature of the constituent plurality of features defines a characteristic of a quantity of the plurality of quantities.

Example Clause T, the computer-readable storage medium of any one of Example Clause O through S, wherein the plurality of data transforms is generated based on a data type of the input dataset.

Conditional language such as, among others, “can,” “could,” “might” or “may,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof.

The terms “a,” “an,” “the” and similar referents used in the context of describing the invention (especially in the context of the following claims) are to be construed to cover both the singular and the plural unless otherwise indicated herein or clearly contradicted by context. The terms “based on,” “based upon,” and similar referents are to be construed as meaning “based at least in part” which includes being “based in part” and “based in whole” unless otherwise indicated or clearly contradicted by context.

In addition, any reference to “first,” “second,” etc. elements within the Summary and/or Detailed Description is not intended to and should not be construed to necessarily correspond to any reference of “first,” “second,” etc. elements of the claims. Rather, any use of “first” and “second” within the Summary, Detailed Description, and/or claims may be used to distinguish between two different instances of the same element (e.g., two different feature sets).

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

It is claimed:

1. A method comprising:
receiving an input dataset comprising a plurality of quantities and an evaluation metric at a large language model;
generating, by the large language model, a plurality of data transforms, each data transform of the plurality of data transforms formatting the input dataset for processing;
generating, by the large language model, a plurality of featurization approaches, each featurization approach defining a feature set for the input dataset comprising a constituent plurality of features derived from the input dataset;
initializing a plurality of candidate machine learning pipelines, each candidate machine learning pipeline implementing a corresponding machine learning model utilizing a data transform of the plurality of data transforms and an associated featurization approach generated by the large language model;
configuring an automated machine learning training module with a plurality of corresponding machine learning models implemented by the plurality of candidate machine learning pipelines to process the input dataset;
evaluating a performance of each of the plurality of corresponding machine learning models implemented by the plurality candidate machine learning based on the evaluation metric; and
selecting a machine learning model from the plurality of corresponding machine learning models implemented by the plurality of candidate machine learning pipelines, the selected machine learning model having a higher performance in relation to the performances of other machine learning models in the plurality of corresponding machine learning models.

2. The method of claim 1, wherein a feature of the constituent plurality of features is a ratio of two quantities of the plurality of quantities.

3. The method of claim 1, wherein a feature of the constituent plurality of features is an aggregate quantity of a subset of the plurality of quantities.

4. The method of claim 1, wherein a feature of the constituent plurality of features is a subdivision extracted from a quantity of the plurality of quantities.

5. The method of claim 1, wherein a feature of the constituent plurality of features defines a characteristic of a quantity of the plurality of quantities.

6. The method of claim 1, wherein the plurality of data transforms is generated based on a data type of the input dataset.

7. The method of claim 1, wherein:
the evaluation metric is selected based on a machine learning task associated with the input dataset;
the machine learning task is a binary classification task identifying a malicious uniform resource locator; and
the evaluation metric is an area under curve metric.

8. A system comprising:
one or more processing units; and
a computer-readable medium having encoded thereon computer-readable instructions that when executed by the one or more processing units, causes the system to:
receive an input dataset comprising a plurality of quantities and an evaluation metric at a large language model;
generate, by the large language model, a plurality of data transforms, each data transform formatting the input dataset for processing;
generate, by the large language model, a plurality of featurization approaches, each featurization approach defining a feature set for the input dataset comprising a constituent plurality of features derived from the input dataset;
initialize a plurality of candidate machine learning pipelines, each candidate machine learning pipeline implementing a corresponding machine learning model utilizing a data transform of the plurality of data transforms and an associated featurization approach generated by the large language model;
configure an automated machine learning training module with a plurality of corresponding machine learning models implemented by the plurality of candidate machine learning pipelines to process the input dataset;
evaluate a performance of each of the plurality of corresponding machine learning models implemented by the plurality candidate machine learning based on the evaluation metric; and
select a machine learning model from the plurality of corresponding machine learning models implemented by the plurality of candidate machine learning pipelines, the selected machine learning model having a higher performance in relation to the performances of other machine learning models in the plurality of corresponding machine learning models.

9. The system of claim 8, wherein a feature of the constituent plurality of features is a ratio of two quantities of the plurality of quantities.

10. The system of claim 8, wherein a feature of the constituent plurality of features is an aggregate quantity of a subset of the plurality of quantities.

11. The system of claim 8, wherein a feature of the constituent plurality of features is a subdivision extracted from a quantity of the plurality of quantities.

12. The system of claim 8, wherein a feature of the constituent plurality of features defines a characteristic of a quantity of the plurality of quantities.

13. The system of claim 8, wherein the plurality of data transforms is generated based on a data type of the input dataset.

14. The system of claim 8, wherein:
the evaluation metric is selected based on a machine learning task associated with the input dataset;
the machine learning task is a regression machine learning task for detecting a security issue; and
and the evaluation metric is a mean absolute error metric.

15. A computer-readable storage medium having encoded thereon computer-readable instructions that when executed by a processing unit causes the system to:
receive an input dataset comprising a plurality of quantities and an evaluation metric at a large language model;
generate, by the large language model, a plurality of data transforms, each data transform formatting the input dataset for processing;
generate, by the large language model, a plurality of featurization approaches, each featurization approach defining a feature set for the input dataset comprising a constituent plurality of features derived from the input dataset;
initialize a plurality of candidate machine learning pipelines, each candidate machine learning pipeline implementing a corresponding machine learning model utilizing a data transform of the plurality of data transforms and an associated featurization approach generated by the large language model;
configure an automated machine learning training module with a plurality of corresponding machine learning models implemented by the plurality of candidate machine learning pipelines to process the input dataset;
evaluate a performance of each of the plurality of corresponding machine learning models implemented by the plurality candidate machine learning based on the evaluation metric; and
select a machine learning model from the plurality of corresponding machine learning models implemented by the plurality of candidate machine learning pipelines, the selected machine learning model having a higher performance in relation to the performances of other machine learning models in the plurality of corresponding machine learning models.

16. The computer-readable storage medium of claim 15, wherein a feature of the constituent plurality of features is a ratio of two quantities of the plurality of quantities.

17. The computer-readable storage medium of claim 15, wherein a feature of the constituent plurality of features is an aggregate quantity of a subset of the plurality of quantities.

18. The computer-readable storage medium of claim 15, wherein a feature of the constituent plurality of features is a subdivision extracted from a quantity of the plurality of quantities.

19. The computer-readable storage medium of claim 15, wherein a feature of the constituent plurality of features defines a characteristic of a quantity of the plurality of quantities.

20. The computer-readable storage medium of claim 15, wherein the plurality of data transforms is generated based on a data type of the input dataset.
